(19) United States
(12) Patent Application Publication
(10) Pub. No.: US 2003/0079124 A1
(43) Pub. Date: Apr. 24, 2003

(54) Secure method for getting on-line status, authentication, verification, authorization, communication and transaction services for web-enabled hardware and software, based on uniform telephone address

(76) Inventor: Oleg Serebrennikov, Moscow (RU)

Correspondence Address: SUGHRUE MION, PLLC, 2100 PENNSYLVANIA AVENUE, N.W., WASHINGTON, DC, 20037, US

(21) Appl. No.: 10/233,426

(22) Filed: Sep. 4, 2002

Related U.S. Application Data
(63) Continuation-in-part of application No. 10/085,717, filed on Feb. 27, 2002.

(30) Foreign Application Priority Data
Oct. 24, 2001 (RU) 2001-128645

(51) Int. Cl. H04L 9/00

(52) U.S. Cl. 713/156; 713/153

(57) ABSTRACT

Methods, systems, computer data signals, recordable media and methods of doing business for wireless or wired network communication between network resources each having a unique telephone number associated therewith, including, among other feature, forming a primary number file (PNF) comprising a uniform telephone address (UTA) which has a telephone number associated with a network resource. Issuing a temporary Digital Certificates containing UTA for use in at least one Temporary Target (TT), the TT serving as a temporary Target or Mover in the network, wherein a CA Switch issues UTA and UTA DC; transfers the UTA and DC directly to Temporary Target Number File or to a reseller; and the reseller assigns the UTA/DC to a particular temporary Target Primary Number File. Performing session encryption, wherein Targets use shorter key pairs in order to accelerate encryption of on-line audio and video streams; and each Target issuing new pair of shorter public and private keys, storing the private key in an internal memory of the Target, the private key being used only for one session, encrypting a new shorter public key with a sending target original private key, or with a receiving target original public key, and transmitting the encrypted message to the receiving target; and receiving target decrypting the received message containing the new shorter Public Key of the sending target and uses the received sending target public key to encrypt/decrypt the session exchange with sending target.

### RELATED APPLICATIONS

This application is a Continuation in Part (CIP) of U.S. patent application Ser. No. 10/085,717 and incorporates herein, by reference, the entire disclosure of said application. The U.S. patent application Ser. No. 10/085,717 claims priority under 35 U.S.C. §119(b) from Russian Patent Application Number 2001128645 dated Oct. 24, 2001. This CIP incorporates herein, by reference, the entire disclosure of Russian Patent Application Number 2001128645.

### FIELD OF THE INVENTION

This invention is in the field of on-line communication. In particular, this invention relates to a system, and a method for facilitating secure on-line communications using uniform telephone address as one of the parameters.

### DESCRIPTION OF THE RELATED ART

Public key cryptography is an approach to enabling secure communications using key pairs. Each key pair includes a public key and a private key. The public key and private key are related so that a message encrypted by one key may be decrypted only by the other, but it is computationally infeasible to deduce the private key given the public key. The private key is typically created and securely held by an entity; while the corresponding public key is typically made widely available. Secure communications between parties may then be enabled by using the parties' public and private keys.

The use of public key cryptography addresses many of the inherent security problems in an open network such as the Internet. However, two significant problems remain. First, parties must be able to access the public keys of other entities in an efficient manner. Second, since in many protocols entities are associated with and in some sense identified by their public keys, there must be a secure method for parties to verify that a certain public key is bound to a certain entity.

A public key management infrastructure (PKI) addresses these two problems. In one common approach, the public key management infrastructure is based on digital certificates, which are used to associate a certain public key to a certain entity with some degree of integrity. The public key management infrastructure typically would include a database of digital certificates, and various operations are provided in order to access and maintain this database. For example, requests for new digital certificates are processed, digital certificates are revoked, and the status of existing digital certificates is designated and checked.

The closest art known is as follows:

U.S. Pat. No. 6,151,624, RealNames, does not provide interoperability between communication networks and the Internet; on-line status check; secure connectivity; support of 3G communication standards=>MMS/I-mode/FOMA and unified communication and messaging.

U.S. Pat. No. 6,324,645, VeriSign discloses use of digital certificates, but does not detail the use of certificates for web-enabled devices; secure purchase and transaction services based on the check of Uniform Telephone Address (UTA) and dynamic Uniform Resource Locators (URL)s;

U.S. Pat. No. 5,793,762 titled “System and method for providing packet data and voice services to mobile subscribers”, and U.S. Pat. No. 5,457,736 titled “System and method for providing microcellular personal communications services (PCS) utilizing embedded switches”: Major difference between these patents and present invention is that besides wireline-to-mobile; mobile-to-wireline; mobile-to-mobile calls the present invention is applicable to browser-to-wireline; browser-to-mobile; mobile-to-browser and wireline-to-browser connectivity therefore providing cross operability not only between Mobile users via Internet but also between all Mobile, Wireline and the Internet users, meaning that Internet user can be a calling party without being a mobile subscriber.

U.S. Pat. No. 5,732,359 titled “Mobile terminal apparatus and method having network inter-operability” addresses interoperability between mobile and satellite communication networks, but does not address interoperability between any telephone communication networks and the Internet.

U.S. Pat. No. 6,353,621 titled “Method to allow seamless service to mobile subscribers across various mobile switching centers supporting multiple intersystem standards”, describes call termination and interoperability method for mobile services generally at the level of multiple switching centers using any protocols (meaning that Internet TCP/IP is included). However, this patent does not provide the same for hardware-to-software and vice versa communication.

U.S. Pat. No. 5,521,962 titled “Temporary storage of authentication information throughout a personal communication system”, describes a method for managing authentication information for mobile users reducing number of authentication information copies distributed within current wireless infrastructure.

The known art does not contemplate a central Internet Switch repository with number files database providing interoperability between Mobile communication network, wireline and the Internet.

### SUMMARY OF THE INVENTION

The drawbacks and functional limitations of the prior art systems and methods described above are overcome by the various embodiments of the present invention which provides inter alia methods, systems, computer data signals, recordable media and methods of doing business including, among other feature, forming a primary number file (PNF) comprising a uniform telephone address (UTA) which has a telephone number associated with a network resource.

One particularly advantageous aspect of the invention provides a method which includes forming a secondary number file and a default number file, the secondary and default number files being mirror images of the primary number file, and storing the default number file at a switch server which provides connectivity services for the network resources and is itself a network resource, and storing the secondary number file at an internet service provider.

Another particularly advantageous embodiment of the invention provides a method which includes issuing a temporary Digital Certificates containing UTA for use in at least one Temporary Target (TT), the TT serving as a temporary Target or Mover in the network, wherein a CA Switch issues UTA and UTA DC; transfers the UTA and DC directly to Temporary Target Number File or to a reseller; and the reseller assigns the UTA/DC to a particular temporary Target Primary Number File.

Yet another particularly advantageous embodiment of the invention provides a method which includes performing session encryption, wherein Targets use shorter key pairs in order to accelerate encryption of on-line audio and video streams; and each Target issuing new pair of shorter public and private keys, storing the private key in an internal memory of the Target, the private key being used only for one session, encrypting a new shorter public key with a sending target original private key, or with a receiving target original public key, and transmitting the encrypted message to the receiving target; and receiving target decrypting the received message containing the new shorter Public Key of the sending target and uses the received sending target public key to encrypt/decrypt the session exchange with sending target.

The foregoing is a general summary of only some of the aspects of the some of the more advantageous embodiments of the invention. Detailed description of the various embodiments of the invention is set forth below, while the scope of the invention is defined by the claims.

### DESCRIPTION OF THE PREFERRED EMBODIMENTS

Definitions:

Secure layer protocols: Secure Sockets Layer (SSL); Microsoft® Passport single sign-in (SSI); other similar.

URL. URL (Uniform Resource Locator) is a unique identifier (such as IP address, Keyword, telephone number or DNS etc.), which uniquely identifies network resources.

IP address. IP (Internet Protocol) address is a numeric URL and represents a layer beneath DNS system; IP addresses are unique by definition; IP addresses may have DNS names assigned for them. The DNS name or Keyword cannot be used if there is no IP address assigned for it.

UTA (Uniform Telephone Address). UTA is a telephone number assigned for networking Target. Each Target has only one UTA assigned for it and therefore each UTA uniquely identifies particular Target. Each UTA has at least one Number File assigned for the UTA and associated with it. UTA system is a URL layer over phone number, IP address and DNS systems. UTA is compatible with Keyword system by RealNames. UTA can be assigned to any networking Target including Internet web resources and telephone fixed or mobile lines.

UTA's Target. Target is a web enabled networking object of any nature such as hardware (such as computing device/appliance, media, chip/processor), software (such as web browser, instant messenger, e-mail enabling software etc.), data (such as web site, page etc.), wave frequency, modulation, division or their composition (for example particular Radio station). Each Target is enabled to require network to assign URL for it. There is only one unique UTA assigned for each Target.

IP address locating Target in the Internet is called Primary IP address and Primary Number File belongs to Target and accessible at Primary IP address. All Targets have web-enabling means such as web server, web browser, and other hardware/software to enable Target managing Primary Number file, connecting, communicating and exchanging via Internet. For Target's Primary number file there should be assigned preferably two mirror copies called Default and Secondary Number files; the files are being located and accessible on-line at Switch and ISP servers accordingly.

Dynamic and Static IP addresses (URLs) and roaming mobile IDs. Each Target can be accessed in the network by using its URL. In the Internet Targets usually have static IP address assigned for them when using leased line (DSL, T1, etc); dial-up or mobile (roaming) Targets usually have temporary dynamic IP address assigned for them through DHCP (Dynamic Host Configuration Protocol) while Target is connected to particular ISP or cell. When roaming, mobile devices numbers are mapped and devices serviced by using such wireless roaming standards as ANSI-41 and GSM-MAP.

ANSI-41

ANSI-41 provides support for roamers visiting your service area, and for your customers when they roam outside your area. When a visiting roamer registers in your service area, for example:

Using the roamer's MIN/ESN, your mobile switching center (MSC) visiting location register (VLR) determines the appropriate MSC home location register (HLR) for routing.

Your MSC directs the message through SS7 network and, if appropriate, through our gateway access to other SS7 networks, to the home MSC/HLR for validation.

The caller's MSC/HLR validates the roamer and sends a response allowing calls to proceed.

When your customers roam outside your service area, the process is the same, but messages flow through the network to your MSC/HLR.

GSM-Map

Much like ANSI-41, GSM-MAP allows for transport of crucial MSC/HLR/VLR registration and seamless roaming data between you and your roaming partner's GSM network, and this message protocol also provides instant access to advanced SS7 related offerings such as Number Portability.

One area in which GSM-MAP and ANSI-41 transport differ is in the area of roamer administration. GSM-MAP networks rely on an International Mobile Station Identifier (IMSI), as opposed to the Mobile ID Number (MIN) used in ANSI-41. The IMSI is a 15-digit identifier, which is made up of the Mobile Country Code (MCC) representing the roamer's home country, the Mobile Network Code (MNC) identifying the home network provider of the user, and lastly the Mobile Station Identification Number (MSIN), which identifies the actual mobile unit. When a visiting roamer registers in your service area, for example:

The roamer's phone is turned on in your service area; your VLR launches a Registration request to the roamer's HLR. Each HLR is identified via a Mobile Country Code and Mobile Network Code.

The HLR responds to your serving VLR and your VLR, in turn, notifies the MSC of the roamer's profile.

The roamer is now registered in your service area.

When your customers roam outside your service area into roaming partners' GSM networks, the process is the same, but messages flow through the network to your MSC/HLR.

UTA's Default, Primary and Secondary URLs. UTA Primary URL is an address locating UTA's Primary Number File associated with Target itself in the Internet. UTA Secondary URL is a URL locating UTA Secondary Number File (the mirror copy of Primary Number File associated with ISP location) in Internet. Secondary Number File is preferably kept at ISP web site. UTA Default URL locates UTA Default Number File which is kept at Switch web server. Secondary URL and Default URL are used preferably while target is off-line, i.e. is not accessible by its Primary URL, and for check and verification purposes.

UTA Number file. Number file is described in detail in U.S. patent application Ser. No. 10/085,717 which is the parent to this CIP. Such a number file is assigned to a particular UTA designating Target.

UTA Default, Primary and Secondary Number files. Number file contains Metadata, associated with UTA. Number file is preferably XML based RDF, CC/PP data file. Default number file is located at Switch server Default URL, which is described below. Primary number file is located at Target Primary URL and the Secondary number file is located at ISP Secondary URL. There could be Tertiary and further URLs providing different or distributed Internet services & connectivity; accordingly they are associated with Tertiary and further number files. Primary Number file preferably contains three URLs i.e. for Default, Primary and Secondary URLs. The Default URL is always the Switch server Primary URL. The Secondary URL is always the Target ISP's Primary URL. Both Default and Primary URLs are provided to Targets when subscribing and stored into Primary Number file during installation or dynamically when connecting to the network. Both Default and Secondary Number files are mirror copies of Primary Number file.

UTA Number file metadata content: The Metadata preferably use XML and compatible RDF, CC/PP and other formats and may contain next data associated with the Target:

Telephone Number (UTA).

Primary URL. Primary URL is not nil if Target is “on-line”, and is nil for “off-line” Target.

Secondary URL

Default URL

Authorization Center Primary URL

CA Primary URL (if different from Switch)

Network Security Primary URL

Authorization Center UTA

CA UTA

Network Security UTA

Primary (Switch) Public Key

Secondary (originating ISP) Public Key

Authorization Center Public Key

CA Public Key (if different from Switch)

Network Security Public Key

On-line status. On-line status data is Primary URL derivative.

Current status of device resources available and required

Purchased resources and current status of purchase

Data related to Network Security policy, contain financial or banking data, e-wallet, proxies, access authorization, authentication and identification datasets, biometric datasets other etc.

User preferences (regular telecom services such as Caller ID, order and terms to switching to order facilities such as text mode, instant messaging mode, SMS mode etc)

Methods and protocols access verification and authorization

Other metadata disclosed in the parent to this CIP application

Other data provided by third parties such as Microsoft Passport or VeriSign certificates etc.

CA (Switch) Digital Certificate (preferably includes all PNF fields with permanent values)

Authorized privileges for Public key cryptography (preferably is a part of DC)

Target' Secure Area Metadata:

**Credit Card Record**

**Bank account information**

**Secure private key file for Public key cryptography**

**Password for disposable handset use**

Target On-line Status Check: IP Address “ping” Command Description

The “ping” command or similar command checks on-line accessibility of particular Target at its IP address. Ping is accessible in manual mode in Windows using prompt Start-Programs-Accessories-Command Prompt. To ping the IP or URL the command string shall be:

ping <IP address>

or

ping <DNS name>

Here is the Ping Command Example:

Microsoft Windows 2000 [Version 5.00.2195] (C) Copyright 1985-2000 Microsoft Corp.

C:\>ping www.names.ru

Pinging www.names.ru [212.24.32.169] with 32 bytes of data:

Reply from 212.24.32.169: bytes=32 time<10 ms TTL=121

Reply from 212.24.32.169: bytes=32 time=10 ms TTL=121

Reply from 212.24.32.169: bytes=32 time=10 ms TTL=121

Reply from 212.24.32.169: bytes=32 time<10 ms TTL=121

Ping statistics for 212.24.32.169:

Packets: Sent=4, Received=4, Lost=0 (0% loss),

Approximate round trip times in milli-seconds:

Minimum=0 ms, Maximum=10 ms, Average=5 ms

C:\>

Web server. This is networking firmware or software installed on particular Target; usually web server provides Internet connectivity, data & script computing, etc. Web server is SSL enabled and therefore supports Public key encryption infrastructure (PKI) and procedures, it can generate Certificate Signature Request (CSR), Public and Private keys, search, retrieve, receive and store Digital Certificate issued by Certification Authority (CA). It can also operate within PKI operating as Mover or Target for the infrastructure. Web server can be firmware—just a chip such as ACE1101MT8 or PIC12C509A/SN (http://world.std.com/˜fwhite/ace/) or software. Web server is always a part of Target but Target may have no web server.

Web browser. This is networking hardware or software. Web browser provides a set of functions that may vary but shall provide at least next functions: addressing & locating Targets in Internet and web enabled communication networks; connecting to chosen Target; screening the Internet static content (HTML, XML, etc.); screening and scoring/visualizing Internet dynamic content & live on-line voice & video exchange using voice & video over IP technology (dynamic mark-up languages, streaming data, voice &video over IP etc). Web browser is SSL enabled and therefore supports Public key encryption infrastructure (PKI) and procedures, it can generate Certificate Signature Request (CSR), Public and Private keys, search, retrieve, receive and store Digital Certificate issues by Certification Authority (CA). It can also operate within PKI operating as Mover or Target for the infrastructure.

UTA Subscription Authority. SA is an authority, which keeps central UTA repository, providing registration, management and resolution services for UTA and associated Number Files. Switch server is a data management engine at SA site.

Certification Authority. CA is an central PKI authority, providing Digital Certificates for UTA Number Files and related SSL services. The CA is preferably the SA.

Switch server. The Switch is Internet server providing on-line connectivity services for subscribed and non-subscribed Targets. Switch is a Central Target and keeps Default Number files providing Default URLs for each one. Being a Target, the Switch server has got its own Default, Primary and Secondary Number files.

Network Security rile. Switch server and ISP may implement and apply Security policy for chosen or all IP communications, connections, calls and transactions. The Policy data are stored in Network Security file available at both Switch and ISP, Default and Secondary Network Security file. Security File may have UTA assigned for it and therefore can be reached in the network by using the Security UTA. Such UTA may be a well-known number like 911 or other local assigned numbers such as 01, 02 and 03 in Russia, etc.

On-line status. For the purposes of the patent application the “on-line status” term is understood as accessibility of particular Target through the web by using its UTA Primary URL (Status is “on-line”) and the “off-line status” term applies to the Target, which is not accessible at its UTA Primary URL (the status is “off-line”).

Mover. Mover is a Target initiating IP call, trying to connect to other Target by using Target's UTA. The calls can be performed via Internet as hardware-to-hardware, hardware to-software, software-to-hardware, and software-to-software IP calls. Mover can provide Target its caller ID and other metadata from Mover Primary Number file. Mover can be anonymous entity.

IP call. IP call is an Internet connection between Mover and Target for data, voice & video point-to-point exchange via Internet using TCP/IP, voice & video over IP technology, other relevant web-enabling means. It can be made as wireline-to-mobile; mobile-to-wireline; mobile-to-mobile calls the present invention claims browser-to-wireline; browser-to-mobile; mobile-to-browser and wireline-to-browser, where mobile is understood as both cell and satellite communication. In secure mode the IP call may use known encryption methods such as RSA, Diffie-Hellman and other, SSL, MS SSI and PKI.

Service Provider or ISP. ISPs are Internet and web enabling communication network Service Providers. Being a Target, each ISP may have its own Default, Primary and Secondary Number files.

Point Of Sales (POS). POS is a UTA node in communication network, providing sales, exchange and transactional services. Each POS may have UTA assigned for it and therefore may be addressed via web-enabled networks.

Implementation

Use of preferable authentication standard means. X.501 recomendations; X.509 directory services; X.519 directory access protocol; Preferably using IETF Kerberos (http://www.ietf.org/html.charters/krb-wg-charter.html); Cryptographic Message Syntax (CMS); other

Digital certificates, encryption issues: Internet X.509 certificates PKI can be used in conjunction with IETF “Use of ECC Algorithms in CMS” http://search.ietforg/internetdrafts/draft-ietf-smime-ecc-06.txt specification to distribute agents' public keys. The use of ECC algorithms and keys within X.509 certificates is specified in

L. Bassham, R. Housley and W. Polk, “Algorithms and Identifiers for the Internet X.509 Public Key Infrastructure Certificate and CRL profile”, PKIX Working Group Internet-Draft, November 2000.

FIPS 186-2, “Digital Signature Standard”, National Institute of Standards and Technology, Feb. 15, 2000.

SECG, “Elliptic Curve Cryptography”, Standards for Efficient Cryptography Group, 2000. Available from www.secg.org/collateral/sec1.pdf.

Financial and transactional services: Preferably implement and use ANSI X9.62-1998, “Public Key Cryptography For The Financial Services Industry: The Elliptic Curve Digital Signature Algorithm (ECDSA)”, American National Standards Institute, 1999; Electronic Commerce Markup Language (ECML)

Primary Number File (PNF) creation. When a user subscribes for the first time to the UTA product & service, the user provides all necessary information including his UTA to the Subscription and Certification authorities and the latter form the Primary Number File. To enable the user to use PNF for transaction and SSL services, CA issues a Digital Certificate (DC) to enable SSL and PKI. Public part of information for PKI is being stored into UTA PNF and available to other PKI users and the private part is being stored securely at Target's memory. DC is signed by CA Private key and contains at least UTA and Target's Public key. The digital certificate complies with the X.509 format; and the UTA is contained in an X.509 extension.

Primary URL assignment and Primary Number file synchronization: Each time when Target enters a network, ISP assigns for it Primary URL; upon assignment this URL is then preferably provided to Target and stored in metadata in Primary Number file; Primary URL record is then preferably stored in Secondary Number file (at ISP) and in Default Number file (at Switch). While entering the network, Switch preferably authenticates Target using DC; Target then synchronizes Primary Number file entries with Secondary and Default Number files. To do so Target takes Secondary and Default URL from PNF and connects to the Secondary and Default Number Files; when connected Target starts metadata synchronization. To authorize and verify Targets and to prevent impostor from entering network resources, the Switch, ISP or any other SSL enabled entity can retrieve Digital Certificate from PNF and decrypt it using CA Public key receiving at least original UTA and Target's Public key; then exchanging via SSL the checking entity can ensure that the user does not personate the Target and the Target has appropriate privileges.

Updating Secondary and Default Number files: ISP continuously and timely updates Secondary number file by connecting to Primary or/and Default number files. Target's “on-line status” can be also checked through regular means of telecommunication service providers and then converted to number file format, stored into Secondary Number file.

Updating Default Number File:

Method 1: Switch server continuously and timely updates the Default Number files with data taken (Switch pulls) or received (ISP push) from Target's Secondary Number files; when call for particular Target is received, Switch server checks this Target's Primary URL in Default number file and if the latter is not nil Switch connects to it; If connection fails Switch terminates the call and sets Default Number file Primary URL field to nil and its status field to “off-line”. Otherwise the Target' “on-line status” can be got using ISP's own means and then retrieved from ISP to Switch server for each particular Target. As optional the Switch server can be set to ping continuously all subscribed targets using their Primary URLs and checking this way their “on-line status” continuously. Each time when on-line status check is complete, the Switch updates the status in the Default number file for each Target/UTA.

Method 2: While entering network each Target connects to Switch server and synchronizes its Primary Number file with Default Number file metadata. Switch server continuously and timely communicates with each particular Target and updates the Default Number files with data taken (Switch pulls) or received (Target push) from Target's Primary Number files; when call for particular Target is received, Switch server retrieves Target's Primary URL from Default Number File and if the Primary URL is not nil Switch connects to it; If it is nil or connection fails Switch terminates the call and sets Target's Primary URL field in Default Number file to nil and its status field to “off-line”.

Making outgoing IP call: When Target's UTA is entered into Mover's Internet browser address bar or other web enabling interface, the Mover connects and communicates with the Switch server as disclosed in the parent of this CIP, and receives Target's metadata from Default Number file; if the UTA's Primary URL is not a nil, Mover attempts to access UTA (Target) by using UTA's Primary URL taken from Target's Default Number File; if the Primary URL is valid and Target responds, the Mover and the Target provide their Digital Certificates to each other and make network security policy check; depending on policy Mover can access Target's Primary number file, and vice versa Target can check Mover Primary number file; Mover and Target compute security data applying security policy; accessing and exchanging data with the Target if privileges allow. Preferably IETF Session Initiation Protocol or similar to be used for exchange between Mover and Target.

When the Target's Primary URL is valid and Mover is calling to Target, but Target does not answer the call, the browser attempts to leave a message in device memory;

When the Primary URL is not valid or nil the browser retrieves Secondary URL and attempts to locate the Secondary Number File and etc. and when responding sequential URL is found the web browser allows composing and leaving there a message of any kind.

Answering incoming IP call: When IP call is received; Target automatically turns into “answer”/“deny” or other applicable mode, rings or otherwise indicates the incoming call; The Target attempts to retrieve Mover's UTA and Digital Certificate from Mover Primary Number file; Target can check UTA and Digital Certificate validity and Target's privileges using PKI. Target then makes a decision to allow or deny Mover' connection in accordance with security/calling policy, privileges and preferences of both parties provided in Number File's metadata and Digital Certificates. If secure call is requested then both parties encrypt the exchange using SSL and PKI, their Private and Public keys. The secure mode allows purchase, payment and other secure transaction services. When check, verification, authentication is complete preferably IETF Session Initiation Protocol or similar to be used for exchange between Mover and Target.

Enabled and Disabled calling ID lists. Each particular Target has a list of other networking Target' IDs related to the particular Target somehow (i.e. telephone number list of friends, partners, relatives etc.). The list can be divided at least in preferably parts: Those Targets, which are not allowed to see on-line status of the particular Target; Those Targets, which are allowed to see the particular Target's on-line status; those Movers which are not allowed to call to the Target; those Movers which are allowed to call to the Target etc. Therefore each Mover can check and receive “on-line status” for only those Targets who allow the Mover to check it. Before calling to particular Target Mover can check whether the Target is on-line and can save calling time if the Target is currently off-line.

Issuance of Digital Certificate (DC) for UTA/Target. When UTA Subscription Authority creates and registers UTA associated with particular Target, and creates Primary Number File for the Target, the Certification Authority (CA) creates a Digital Certificate (DC); to allow DC creation the Target shall be SSL enabled and:

The Target provides completes all required fields of Primary Number File (preferably all PNF fields with permanent values) and generates Certificate Signature Request (CSR) file, Public key and Private key; The Private Key is being securely stored at the Target's memory;

The Target provides its CSR and Public key to the UTA CA for signature

The Public key file and UTA Primary Number File are being encrypted (signed) by CA (Switch) with CA Private Key, and the encrypted message represents a UTA Digital Certificate;

The CA signs the CSR and returns it to the Target as Target's Digital Certificate (DC). The DC includes UTA, and the digital certificate is digitally signed by the CA.

The Target stores the DC in the Target Primary Number file and makes it available for SSL procedure.

Verification and authentication are used to prevent impostors from entering network and particular Target resources using particular Target's PNF, the digital Certification Authority, Switch or Target:

Simple authentication in non-secure mode (SSL is disabled): Takes UTA from Mover's Primary Number File; retrieves Default, Primary and Secondary Number Files for Mover's UTA; verifies Mover's UTA by comparing key data from Secondary and Default Number Files with those in Primary Number File; if verification is complete successfully the Mover is authorized to use requested services and the Target is provided with verification from Switch;

Strong authentication in secure mode (SSL is enabled) where Target A (A) authenticates Target B (B):

B:

encrypts the Dataset B using Private Key B forming Dataset B1

composes a check message containing DC B and Dataset B1

transmits the check message to A; and

A:

Retrieves DC B and Dataset B1 from the check message

Decrypts DC B using CA (Switch) Public Key

retrieves Dataset B and Public Key from the decrypted B's DC

decrypts the Dataset Blusing Public Key B forming Dataset A

compares the Dataset A with Dataset B and if the Dataset A is identical to the Dataset B the A makes decision that B possesses correct CA's certified Private Key B and the verified Dataset B, therefore B is authentic;

Where Dataset B is preferably a part of DC B and preferably the UTA B; or other DC B fields, or some or all the DC B fields; or DC B itself.

Other similar/applicable authentication procedure can be set up based on particular cryptography use.

Verification authentication and authorization by Target. To authorize and verify Movers, and to prevent impostors from entering Target resources personating/using particular Mover's PNF, the Target via SSL

Retrieves Digital Certificate from the Mover's Primary Number File; decrypts the DC with CA (Switch) public key; checks validity of the DC; authenticates the Mover; allows Mover to connect to Target based on Mover's privileges if the check is successful and denies connection if the check failed.

Verification authentication and authorization by Mover. In order to verify that a connection made to valid Target and not to an impostor, and to prevent impostors from entering Movers resources using particular Mover's PNF, when connecting to Target, Mover retrieves Target's DC from Target's PNF; decrypts it by using CA (Switch) Public Key; verifies Target's UTA and checks Target privileges.

Secured transaction services between Targets representing Buyer and Seller.

IP transaction services can be provided based on applicable Network Security policy and user's privileges using Secure Socket Layer (SSL), PKI and UTA CA services. The Public key cryptography allows verifying UTA though Public key cryptography infrastructure. SSL (secure socket layer) enables PKI usage for secure on-line e-commerce, banking etc. transaction services, data and live interaction exchange. All are based on the use of DC and its content. The payment between Buyer and Seller can be processed using procedure similar to credit card payment authorization procedure described below:

Purchase Message

“Purchase message” is a message composed by a Buying Target. “Purchase message” contains preferably

Seller DC

Seller Primary URL (optional)

Purchase data (currency and money values, time of purchase, purchase/transaction number and other appropriate purchase information)

“Purchase message” is agreement to buy, digitally signed i.e. encrypted using Buyer's Private Key.

Charge Message

“Charge message” is a message composed by a Selling Target. “Charge message” contains preferably

Buyer DC

Buyer Primary URL (optional)

“Purchase message” signed using Buyer's Private Key.

Purchase data (currency and money values, time of purchase, purchase/transaction number and other appropriate purchase information)

“Charge message” is agreement to sell, digitally signed i.e. encrypted using Seller's Private Key.

Authorization Message

“Authorization message” is a message composed by an Authorization Center. “Authorization message>> contains preferably

Buyer DC

Buyer Primary URL (optional)

“Purchase message” signed using Buyer's Private Key.

Purchase data (currency and money values, time of purchase, purchase/transaction number and other appropriate purchase information)

“Authorization message” is an authorization, digitally signed i.e. encrypted using Authorization Center's Private Key.

“Pay” Authorization Method

comprising the steps:

Establishing wired or wireless connection between the Buyer and Seller

Displaying or otherwise indicating the Name of purchase and the value of purchase, other appropriate purchase/transaction data to the user

Waiting to receive the Buyer's authorization for purchase and if authorization is granted:

Executing preferably Strong Buyer/Seller cross-authentication in secure mode

If Seller and Buyer are authentic, Buyer:

Composing “Purchase message”

Connecting to the Authorization Center using Authorization Center Primary URL

Executing Strong cross-authentication with the Authorization Center in secure mode if applicable

Transmitting the “Purchase message” to the Authorization Center

The Authorization Center

decrypts the “Purchase message” using Buyer's Public Key taken from Buyer's DC during authentication AND

Authorization Center

composes the “Authorization message”

transmits the “Authorization message” to the Buyer

Buyer transmits the “Authorization message” to the Seller

the Seller decrypts the “Authorization message” using Authorization Center's Public key

OR Authorization Center

resolves via Switch the Seller Primary URL using Seller UTA taken from Seller DC; OR takes Seller Primary URL from “Purchase message”

connects to Seller using Seller Primary URL

authenticates the Seller and if Seller is authentic:

verifies the purchase parties and data

composes the “Authorization message”

transmits the “Authorization message” to the Seller

the Seller decrypts the “Authorization message” using Authorization Center's Public key

the Seller allows the purchase if the payment is authorized

“Charge” Authorization Method

The method includes these steps:

Establishing wired or wireless connection between the Buyer and Seller

Displaying or otherwise indicating the Name of purchase and the value of purchase, other purchase/transaction data to the user

Waiting to receive the Buyer's authorization for purchase and if authorization is granted:

Executing preferably Strong Buyer/Seller cross-authentication in secure mode

If Seller and the Buyer are authentic, Buyer:

Composing “Purchase message”

Transmitting the “Purchase message” to the Seller; The Seller:

decrypts the “Purchase message” using Buyer's Public Key taken from Buyer's DC and verifies the purchase data if applicable to policy and if purchase data is correct

composes “Charge message”

connects to the Authorization Center using Authorization Center Primary URL

Executing Strong cross-authentication with the Authorization Center in secure mode if applicable to policy and if cross-authentication succeeds,

transmits the “Charge message” to Authorization Center; the Authorization Center:

decrypts the “Charge message” using Seller Public Key and retrieves and decrypts “Purchase message” using Buyer's Public Key taken from Buyer's DC

verifies the purchase parties and data

composes “Authorization message”

transmits “Authorization message” to Seller

the Seller decrypts the “Authorization message” using Authorization Center's Public key

the Seller allows the purchase if the payment is authorized

Credit card record. The credit card record (CCR) is typical credit card record. The CCR is typically recorded on the credit card magnet stripe or in the smart card internal memory or in another credit card memory.

Credit card authorization method. In order to use credit card for on-line transactions the CCR must be taken from the credit card and saved in the Target' secure area metadata. Then CCR is used as described in Authorization methods. If it is required by particular Credit card system (such as VISA, MasterCard or other) to change CCR when authorizing particular transaction, the changed CCR is being changed by the Credit Card system and returned to the Target encrypted using the Target Public Key, then the received CCR is decrypted by the Target using its Private Key and stored in the Target' secure area metadata for further use.

Bank account charge method. Bank account charge can be deployed in a way similar to the Credit card authorization method.

Temporary UTA. In order to reduce cost per call and increase service accessibility & flexibility, Temporary Digital Certificates containing UTA can be issued by CA (Switch) and used for web-enabled disposable telephone handsets and web browsers or other networking objects/Targets all further called Temporary Targets (TT); they all can serve as temporary Targets or Movers in the network. CA (Switch) issues UTA and UTA DC; transfers the UTA and DC directly to Temporary Target Number File or to reseller; and the reseller assigns the UTA/DC to particular temporary Target Primary Number File.

Such disposable handsets may use Transaction, Text, Voice & Video over IP exchange only and be sold and set up for use with or without assignment of static (permanent) network UTA (telephone number) for them. When purchased handset is turned on, it prompts user: to manually type/use particular preset UTA, or set to automatically choose a dynamic UTA provided by network.

Semi static UTA mode: If user chooses to use particular UTA, a handset preferably requires to type a “Password for temporary UTA” to verify the user's rights to use the UTA (the Password is similar to Personal Identification Number for GSM SIM card); when the password is stored, handset connects to UTA issuing authority' (CA, Switch, ISP, reseller etc) server via SSL and verifies the “Password for temporary UTA” OR verifies the Password with the encrypted Password record contained in the Handset secured memory area; if the check is successful, the user is granted access to network resources using chosen UTA and is treated as an original UTA user; if the check fails the handset can be denied, blocked or reported stolen based on security policy; OR

Particular UTA with DC can be assigned and valid through a standard period of time or number of connections/transactions for the handset/software and if assigned, such UTA shall be typed (it may be preset to appear in interface when handset is turned on) and should be confirmed for use by the user;

Dynamic UTA mode: When after purchase user turns on a handset for the first time, the handset connects via Internet to the Switch server; Switch server registers the handset in the network and assigns dynamic UTA and temporary Default Number File for it; Default Number File is a copy of Primary Number File; the dynamic UTA can be used only for duration of each particular call unless the user requires to hold the UTA for a standard period of time or based on other standard terms of use. Dynamic UTA is revoked after the call is disconnected or assigned and held for the handset for standard period of time if required by user. In order to get the UTA, handset shall be enabled to update its Primary Number File with the particular UTA and the CA shall issue a DC containing the UTA and assign it to the handset as described above.

PNF as Digital Identity Dataset. PNF can be used as a Digital Identity Dataset including all identifying information required for particular verification, authentication, and authorization and transaction purposes.

Session encryption using new shorter Key pair. In order to accelerate encryption of on-line audio and video streams Targets may use Shorter session Key-pairs.

To do so, each Target:

issues new pair of shorter Keys (public and private)

Private Key is to be stored safely in Target' internal memory and used only for the one session

each Target encrypts the new shorter Public Key with the Sending Target Original Private Key or with Receiving Target Original Public Key and transmits the encrypted message to the Receiving Target

Receiving Target decrypts the received message containing the new shorter Public Key of the Sending Target and uses the received Sending Target Public Key to encrypt/decrypt the session exchange with Sending Target.

It is understood that in Public Key Infrastructure Targets can encrypt a message (stream):

using the Receiving Target Public Key and the Receiving Target decrypts the message using its Receiving Target's Private Key

using the Sending Target's Private Key and the Receiving Target decrypts the message using Sending Target's Public Key

Business model 1: selling UTA, which is valid for a period of time or number or fixed money value of services provided etc.

Business model 2: selling Digital Certificates where UTA is a main verifiable part and privileges contain terms of use based on a time period or number or fixed money value of services provided etc.

Business model 3: Selling PNF with permanent UTA for permanent Targets or without permanent UTA for Temporary Targets.

Business model 4: Selling media (SIM cards for GSM and later 3G standards, CD, DVD, or other media) with PNF files recorded on the media.

Business model 5: Selling record able memory chip or processor (SIM cards for GSM and later 3G standards, CD, DVD, or other media) with PNF files recorded on the memory.

Business model 6: Selling PNF as a Digital Identity Dataset.

Business model 7: Selling UTA and/or Number File resolutions (on per resolution charge basis).

Business model 8: Selling UTA and/or Number File data to third party (on per provision charge basis).

Business model 9: Selling UTA and/or Number File authentication services (on per authentication charge basis).

Business model 10: Selling UTA and/or Number File charge authorization services (on per authorization charge basis).

Business model 11: Selling UTA Software Development Kit (SDK) realizing functionality of all described methods.

While various implementations and methods of getting on-line status, authentication, verification, authorization, communication and transaction services for web-enabled hardware and software, based on uniform telephone address according to the present invention have been described in detail, a skilled artisan will readily appreciate that numerous other implementations and variations of these implementations and methods are possible without departing from the spirit of the invention. Accordingly, the scope of the invention is defined by the claims set forth below.

I claim:

1. A method for wireless or wired network communication between network resources each having a unique telephone number associated therewith, said method comprising:
forming a primary number file (PNF) comprising a uniform telephone address (UTA) which has a telephone number associated with a network resource;
forming a secondary number file and a default number file, said secondary and default number files being mirror images of said primary number file;
storing said default number file at a switch server which provides connectivity services for said network resources and is itself a network resource; and
storing said secondary number file at an internet service provider.

2. The method as claimed in claim 1, wherein said method further comprises issuing a digital certificate to a network resource to enable use of said primary number file for secure transactions and secure layer protocols, said digital certificate comprising said network resource's telephone number.

3. The method as claimed in claim 2, wherein said issuing a digital certificate comprises:
storing a public part of information for said digital certificate and said telephone number in said primary file, whereby the public part is available to at least some of said network resources; and
storing a private part of information for said digital certificate in a local memory of said network resource.

4. The method as claimed in claim 1, wherein digital certificate complies with the X.509 format, and said uniform telephone address is contained in an X.509 extension.

5. The method as claimed in claim 1, further comprising assigning to a network resource a Primary URL each time when said network resource enters a network.

6. The method as claimed in claim 5 further comprising:
storing said Primary URL in metadata in said PNF;
storing said Primary URL record in Secondary Number File (SNF) at an ISP and in Default Number file at a Switch.

7. The method as claimed in claim 5, wherein:
while entering the network, a Switch authenticates said network resource using said DC;
said network resource then synchronizes entries of said PNF with SNF and Default Number Files (DNF).

8. The method as claimed in claim 6, wherein, said network resource takes Secondary and Default URL from said PNF and connects to the SNF and DNF, and
when connected said network resource starts metadata synchronization.

9. The method as claimed in claim 1, further comprising authorizing and verifying network resources, and preventing a user impersonating said network resource from entering network resources, wherein:
the Switch, ISP or SSL enabled entity retrieves DC from PNF and decrypts said DC using CA Public key, receiving at least original UTA and Target's Public key.

10. The method as claimed in claim 1, further comprising updating Secondary and Default Number files, wherein ISP updates Secondary number file by connecting to Primary or/and Default number files.

11. The method as claimed in claim 10, wherein said updating Default Number file comprises updating the Default Number files with data taken by a Switch or received by ISP from network resources' Secondary Number files,
when a call for a particular network resources is received, said Switch server checks said network resource's Primary URL in Default number file and if the latter is not nil, said Switch connects to said network resource, and
if connection fails, said Switch terminates the call and sets Default Number file Primary URL field to nil and its status field to off-line.

12. The method as claimed in claim 10, wherein the network resource's on-line status is obtained by ISP's own means and then retrieved from ISP to Switch server for each particular network source.

13. The method as claimed in claim 10, wherein the Switch server pings continuously all subscribed network resources using their Primary URLs and checking “on-line status” of said network resources continuously, and
wherein each time when on-line status check is complete, the Switch updates the status in the Default number file for each network resource.

14. The method as claimed in claim 1, further comprising updating Secondary and Default Number files, wherein while entering network each network resource connects to a Switch server and synchronizes its Primary Number file with Default Number file metadata.

15. The method as claimed in claim 14, wherein Switch server continuously communicates with each particular network resource and updates the Default Number files with data taken by said Switch pulls or received from said network resource Primary Number files,
when call for particular network resource is received, said Switch server retrieves from Default Number File a Primary URL of said network resource.

16. The method as claimed in claim 15, wherein
if the Primary URL is not nil, a Switch establishes a connection, and
if the Primary URL is nil or said connection fails, the Switch terminates the call, sets to nil Primary URL field in Default Number file of said network resource, and sets its status field to off-line.

17. The method as claimed in claim 1, wherein said communication method comprises making an outgoing IP call from a Mover network resource to a Target network resource, said method further comprising:
entering an UTA of said Target into a web enabling interface of said Mover;
said Mover connecting and communicating with said Switch server; and
said Mover receiving metadata of said Target from said Default Number file.

18. The method as claimed in claim 17, wherein
if a Primary URL of said UTA is not a nil, Mover attempts to access said UTA of said Target by using said Primary URL of said UTA taken from Default Number File of said target,
if the Primary URL is valid and said Target responds, the Mover and the Target provide their respective Digital Certificates to each other and make network security policy check;
whereby, depending on said policy, Mover is provided with access to Primary number file of said Target, and Target is provided with access to Primary number file of said Mover, Mover and Target compute security data applying security policy, and said Mover accesses and exchanges data with the Target if privileges allow.

19. The method as claimed in claim 18, wherein IETF Session Initiation Protocol is used for exchange between said Mover and said Target.

20. The method as claimed in claim 17, wherein when the Primary URL of said Target is valid, said Mover is calling to said Target, and said Target does not answer the call, the browser attempts to leave a message in memory; and
when the Primary URL is not valid or nil the browser retrieves Secondary URL and attempts to locate the Secondary Number File and when a responding sequential URL is found the web browser allows composing and leaving said message.

21. The method as claimed in claim 1, wherein said communication method comprises answering an incoming IP call from a Mover network resource received by a Target network resource, said method further comprising:
automatically turning said Target into receive mode which include providing indication of the incoming IP call;
said Target attempting to retrieve UTA of said Mover and a Digital Certificate from said Mover Primary Number file;
said Target checking UTA and Digital Certificate validity and privileges of said Target; and
said Target deciding to allow or to deny connection of said Mover in accordance with security/calling policy, privileges and preferences of both said Target and said Mover provided in metadata of said Number File and said Digital Certificates.

22. The method according to claim 21, wherein if said IP call is a secure call then both said Mover and said Target encrypt the exchange using SSL and PKI, their respective Private and Public keys.

23. The method according to claim 22, wherein said secure call facilitates purchase, payment and other secure transaction services.

24. The method according to claim 22, wherein when check, verification, or authentication is complete, IETF Session Initiation Protocol is used for exchange between said Mover and said Target.

25. The method as claimed in claim 1, wherein said communication method comprises establishing communication between Mover and Target network resources, said method further comprising:
providing for each particular target a list of IDs of other networking Targets and Movers related to the particular Target; and
dividing said list into parts comprising: first IDs of Targets which are not allowed to see on-line status of the particular Target, second IDs of Targets, which are allowed to see the particular Target's on-line status, third IDs of Movers which are not allowed to call to the particular Target and fourth IDs of Movers which are allowed to call to the particular Target,
whereby each of said Movers can check and receive on-line status for only said Targets who allow the Mover to check on-line status thereof.

26. The method as claimed in claim 25 wherein, before calling to said particular Target, a Mover having one of said fourth IDs is able to check whether said particular Target is on-line; and stop attempting to establish communication with said particular Target if said particular Target is currently off-line.

27. The method as claimed in claim 25, wherein said list of IDs comprises telephone numbers of said other Targets.

28. The method as claimed in claim 1, wherein
said communication method comprises establishing communication between Mover and Target network resources,
an UTA Subscription Authority creates and registers UTA associated with a particular Target and creates a Primary Number File for the particular Target,
a Certification Authority (CA) creates a Digital Certificate (DC), and
said particular Target is SSL enabled,
said method further comprising:
said particular Target providing required fields of Primary Number File and generates Certificate Signature Request (CSR) file, Public key and Private key files, said Private Key being securely stored in a memory of said particular target;
said particular Target providing its CSR and Public key to the UTA CA for signature, said Public key file and said UTA Primary Number File being encrypted by CA with CA Private Key, and the encrypted message representing a UTA Digital Certificate;
said CA encrypting said CSR and returning said CSR to said particular Target as a Digital Certificate (DC) of said particular Target; and
said particular Target storing said DC in the Primary Number file of said particular Target and making said DC available for SSL procedure.

29. The method according to claim 28 wherein said required fields are PNF fields with permanent values.

30. The method according to claim 28 wherein said CA is a switch server.

31. The method according to claim 28 wherein said DC includes UTA, and the digital certificate is digitally signed by the CA.

32. The method as claimed in claim 1, wherein
said communication method comprises establishing communication between Mover and Target network resources and performing authentication in non-secure mode, and
said switch server is a Certification Authority (CA),
said method further comprising:
at least one of the digital Certification Authority, Switch server and a Target network resource taking UTA from Primary Number File of a Mover; retrieving Default, Primary and Secondary Number Files for UTA of said Mover; verifying said UTA of said Mover by comparing key data from Secondary and Default Number Files with those in Primary Number File; and, if said verification is successful, authorizing said Mover to use requested services and providing said Target with verification from said Switch server.

33. The method as claimed in claim 32, wherein SSL is disabled.

34. The method as claimed in claim 1, wherein
said communication method comprises establishing communication between Mover and Target network resources and performing authentication in secure mode,
said switch server is a Certification Authority (CA), and
a second target network resource authenticates a first target network resource,
said method further comprising:
said first target encrypting a fist dataset using a first Private Key thereby forming first new dataset;
said first target composing a fist check message containing a first Digital Certificate (DC) and said first new dataset;
said first target transmitting said first check message to said second target;
said second target retrieving said first DC and said first new dataset from said fist check message;
said second target decrypting said first DC using a Public Key of said CA;
said second target retrieving said first dataset and said Public Key from the decrypted first DC;
said second target decrypting said first new dataset using said first Public Key forming a second dataset;
said second target comparing said second dataset with said first dataset; and
if said second dataset is identical to said first Dataset, said second target decides that said first target possess correct first Private Key and the verified first dataset, thereby authenticating said first target.

35. The method as claimed in claim 34, wherein SSL is enabled

36. The method as claimed in claim 34, wherein said first dataset is a part of at least one of said first DC, said first UTA, and other first DC fields, or is a part of some or all said first DC fields, or is a first DC.

37. The method as claimed in claim 1, wherein
said communication method comprises establishing communication between Mover and Target network resources,
said Target performing verification authentication and authorization of said mover, and
said switch server is a Certification Authority (CA),
said method further comprising:
said Target retrieving Digital Certificate (DC) from a Primary Number File of said Mover via SSL;
said Target decrypting the DC with a public key of said CA;
said Target checking validity of the DC;
said Target authenticating said Mover;
said Target allowing said Mover to connect to said Target based on privileges of said Mover if the check is successful; and
said Target denying said connection if the check fails.

38. The method as claimed in claim 1, wherein
said communication method comprises establishing communication between Mover and Target network resources,
said Mover performing verification authentication and authorization of said Target, and
said switch server is a Certification Authority (CA),
said method further comprising:
when connecting to said Target, said Mover retrieving Digital Certificate (DC) of said Target from PFN of said Target;
said Mover decrypting said DC by using Public Key of said CA; and
said Mover verifying UTA of said Target and checking privileges of said Target.

39. The method as claimed in claim 1, wherein
said switch server is a Certification Authority (CA), and
said communication method further comprises providing secure transaction services between Buying Target network resources and Selling Target network resources.

40. The method according to claim 39, wherein said secure transaction services are provided using Secure Socket Layer (SSL), PKI and UTA CA services.

41. The method according to claim 39, wherein said secure transaction includes processing payment between a Buying target and a Selling target, said method further comprising said Buying Target composing a purchase message, said purchase message comprising:
a DC of said Selling Target; and
Purchase data.

42. The method according to claim 41, wherein said purchase data includes at least one of currency and money values, time of purchase, and purchase/transaction number.

43. The method according to claim 41, wherein said purchase message further comprises a Primary URL of said Selling target.

44. The method according to claim 41, wherein said purchase message is an agreement to buy, digitally encrypted using a Private Key of said Buying target.

45. The method according to claim 41, said method further comprising said Selling Target composing a charge message, said charge message comprising:
a DC of said Buying Target;
said Purchase message signed using a Private Key of said Buying target; and
said Purchase data.

46. The method according to claim 45, wherein said charge message further comprises a Primary URL of said Buying target.

47. The method according to claim 45, wherein said charge message is an agreement to sell, digitally encrypted using a Private Key of said Selling Target.

48. The method according to claim 45, said method further comprising an Authorization Center composing an authorization message, said authorization message comprising:
a DC of said Buying Target;
said Purchase message signed using a Private Key of said Buying target; and
said Purchase data.

49. The method according to claim 48, wherein said authorization message further comprises a Primary URL of said Buying target.

50. The method according to claim 48, wherein said authorization message is an authorization, digitally encrypted using a Private Key of said Authorization Center.

51. The method according to claim 48, further comprising:
establishing wired or wireless connection between said Buying target and said Selling target;
displaying or otherwise indicating purchase/transaction data to said Buying and Selling target, said purchase transaction data comprising a purchase description and a value of said purchase;
waiting to receive an authorization of said Buying target for said purchase and if said authorization is granted:
executing Buyer/Seller cross-authentication;
if said Selling Target and said Buying target are authentic, then
said Buying target composes said purchase message;
said Buying target connects to the Authorization Center using Primary URL of the Authorization Center;
said Buying target executes cross-authentication with the Authorization Center; said Buying target transmits said purchase message to the Authorization Center; and
either:
said Authorization Center decrypts said purchase message using said Public Key of said Buying target taken from DC of said Buying target during authentication;
said Authorization Center composing said authorization message;
said Authorization Center transmitting said Authorization message to said Buying target;
said Buying target transmits said Authorization message to said Selling target;
the Selling target decrypts said Authorization message using a Public key of said Authorization Center;
or:
said Authorization Center resolves via said Switch server Primary URL of said Selling target using UTA of said Seller taken from DC of said Selling target, or takes Primary URL of said Selling Target from said Purchase message;
said Authorization Center connects to said Selling target using said Primary URL of said Selling target;
said Authorization Center authenticates the Selling target and if
Selling target is authentic:
said Authorization Center verifies said Selling Target and said Buying target, and said purchase data;
said Authorization Center composes said Authorization message;
said Authorization Center transmits said Authorization message to said Selling target; and
said Selling target decrypts said Authorization message using said Public key of said Authorization Center.

52. The method according to claim 51, wherein the Seller allows the purchase if the payment is authorized.

53. The method according to claim 51, wherein said Buyer/Seller cross-authentication is a Strong Buyer/Seller cross-authentication in secure mode.

54. The method according to claim 48, further comprising:
establishing wired or wireless connection between said Buying target and said Selling target;
displaying or otherwise indicating purchase/transaction data to said Buying and Selling target, said purchase transaction data comprising a purchase description and a value of said purchase;
waiting to receive an authorization of said Buying target for said purchase and if said authorization is granted:
executing Buyer/Seller cross-authentication;
if said Selling Target and said Buying target are authentic, then
said Buying target composes said purchase message;
said Buying target transmits said purchase message to said Selling target;
said Selling target decrypts said purchase message using a Public Key of said Buying target taken from DC of said Buying target, verifies the purchase data, and if applicable to policy and if purchase data is correct then
said Selling Target composes said Charge message;
said Selling Target connects to said Authorization Center using Primary URL of said Authorization Center;
said Selling Target executes cross-authentication with the Authorization Center, and if cross-authentication succeeds:
said Selling target transmits said Charge message to said Authorization Center;
said Authorization Center decrypts said Charge message using a Public Key of said Selling target and retrieves and decrypts said Purchase message using said Public Key of said Buying target taken from said DC of said Buying target;
said Authorization Center verifies the purchase data, and Selling and Buying targets;
said Authorization Center composes said Authorization message;
said Authorization Center transmits said Authorization message to said Selling target; and
said Selling target decrypts said Authorization message using Public key of said Authorization Center.

55. The method as claimed in claim 54, wherein said Selling target allows the purchase if the payment is authorized.

56. The method as claimed in claim 54, wherein said Selling target executes Strong cross-authentication with the Authorization Center in secure mode.

57. The method as claimed in claim 1, wherein said internet service provider is said switch server and said second number file is said default number file.

58. A method for wireless or wired network communication comprising:
issuing a temporary Digital Certificates containing UTA for use in at least one Temporary Target (TT), said TT serving as a temporary Target or Mover in the network,
wherein a CA Switch issues UTA and UTA DC; transfers the UTA and DC directly to Temporary Target Number File or to a reseller; and the reseller assigns the UTA/DC to a particular temporary Target Primary Number File.

59. The method as claimed in claim 58, wherein said TT is a disposable handset which uses at least one of Transaction, Text, Voice and Video over an IP exchange only and with or without assignment of a permanent network UTA.

60. The method as claimed in claim 58, wherein when a TT is turned on, said TT prompts a user to manually enter a UTA, or to use a particular preset UTA.

61. The method as claimed in claim 58, wherein, when a TT is turned on, said TT is set to automatically choose a dynamic UTA provided by a network.

62. The method as claimed in claim 60, wherein
the user chooses to use a particular UTA, the TT request the user to enter a password for the temporary UTA, to verify the user's rights to use the UTA; when the password is stored, handset connects to UTA issuing authority server via SSL and verifies the password for the temporary UTA, or verifies the password with an encrypted password record contained in a secured memory area of the TT; if the check is successful, the user is granted access to network resources using chosen UTA and is treated as an original UTA user; if the check fails the handset can be denied, blocked or reported stolen based on security policy; or
a particular UTA with DC is assigned and remains valid through a predetermined period of time or a number of connections/transactions for the handset/software, and, if assigned, the particular UTA is subject to confirmation for use by the user;

63. The method as claimed in claim 62, wherein the password is similar to a Personal Identification Number for a GSM SIM card.

64. The method as claimed in claim 62, wherein the UTA issuing authority is one of a CA, Switch, ISP and reseller.

65. The method as claimed in claim 61, wherein, when the TT is turned on for the first time,
the TT connects via Internet to a Switch server;
the Switch server registers the TT in the network and assigns dynamic UTA and temporary Default Number File for the TT;
wherein the Default Number File is a copy of Primary Number File; the dynamic UTA is used only for duration of each particular call unless the user requires to hold the UTA for a standard period of time or based on other standard terms of use.

66. The method as claimed in claim 65, wherein Dynamic UTA is being revoked after the call is disconnected or assigned and held for the TT for a standard period of time if required by the user.

67. The method as claimed in claim 65, wherein to retrieve the UTA, TT is enabled to update its Primary Number File with a particular UTA and the CA issues a DC containing the UTA and assigns the DC the handset.

68. The method according to claim 1, wherein the PNF is used as a Digital Identity Dataset comprising all identifying information required for particular verification, authentication, and authorization and transaction purposes.

69. A method for session encryption, wherein Targets use shorter key pairs in order to accelerate encryption of on-line audio and video streams, said method comprising:
each Target
issuing new pair of shorter public and private keys;
storing the private key in an internal memory of said Target, said private key being used only for one session;
encrypting a new shorter public key with a sending target original private key, or with a receiving target original public key; and
transmitting the encrypted message to the receiving target; and
receiving target decrypting the received message containing the new shorter Public Key of the sending target and uses the received sending target public key to encrypt/decrypt the session exchange with sending target.

70. The method as claimed in claim 69, wherein the target encrypts a message using the receiving target public key and the receiving target decrypts the message using the receiving target's private key.

71. The method as claimed in claim 69, wherein the target encrypts a message using the sending target's private key and the receiving target decrypts the message using the sending target's public key.

72. The method as claimed in claim 23, wherein at least one of said purchase, payment and other secure transaction services uses a credit card, said credit card having a credit card record (CCR).

73. The method as claimed in claim 72, wherein said CCR is recorded on the credit card magnet stripe or in the smart card internal memory.

74. The method as claimed in claim 72, further comprising credit card authorization wherein the CCR is retrieved from the credit card and saved in the Target's secure area metadata.

75. The method as claimed in claim 74, wherein if it is required to change CCR when authorizing a particular transaction, the changed CCR is changed by a Credit Card system issuing the card and returned to the Target encrypted using the Target Public Key, then the received CCR is decrypted by the Target using the Private Key of the target and stored in the Target's secure area metadata.

76. The method as claimed in claim 23, wherein at least one of said purchase, payment and other secure transaction services uses a bank charge account.

77. The method as claimed in claim 76, wherein said bank charge account is one of a checking account and a savings account.

78. A system comprising:
a plurality of wireless or wired network resources each having a unique telephone number associated therewith;
a switch server which provides connectivity services for said network resources and is itself a network resource;
a primary number file (PNF) comprising a uniform telephone address (UTA) which has a telephone number associated with at least one of said network resources;
a secondary number file; and
a default number file,
wherein said secondary and default number files are mirror images of said primary number file,
said default number file is stored at said a switch server, and said secondary number file is stored at said internet service provider.

79. The system as claimed in claim 78, further comprising means for issuing a digital certificate to at least one of said network resources to enable use of said primary number file for secure transactions and secure layer protocols, said digital certificate comprising said network resource's telephone number.

80. The system as claimed in claim 79, wherein said means for issuing said digital certificate comprises:
storage means for storing a public part of information for said digital certificate and said telephone number in said primary file, whereby the public part is available to at least some of said network resources; and
storage means for storing a private part of information for said digital certificate in a local memory of at least one of said network resources.

81. The system as claimed in claim 78, wherein digital certificate complies with the X.509 format, and said uniform telephone address is contained in an X.509 extension.

82. The system as claimed in claim 78, further comprising means for assigning to at least one of said network resources a Primary URL each time when said at least one of said network resources enters a network.

83. The system as claimed in claim 82, further comprising:
an internet service provider (ISP);
storage means for storing said Primary URL in metadata in said PNF;
storage means for storing said Primary URL record in Secondary Number File (SNF) at said ISP and in Default Number file at said Switch.

84. The system as claimed in claim 82, wherein:
while entering the network, said Switch authenticates said network resource using said DC;
said network resource then synchronizes entries of said PNF with SNF and Default Number Files (DNF).

85. The system as claimed in claim 83, wherein, said network resource takes Secondary and Default URL from said PNF and connects to the SNF and DNF, and
when connected said network resource starts metadata synchronization.

86. The system as claimed in claim 78, further comprising means for authorizing and verifying at least one of said network resources, and preventing a user impersonating said at least one of said network resources from entering said network resources, wherein:
the Switch, ISP or SSL enabled entity retrieves DC from PNF and decrypts said DC using CA Public key, receiving at least original UTA and Target's Public key.

87. The system as claimed in claim 78, further comprising means for updating Secondary and Default Number files, wherein ISP updates Secondary number file by connecting to Primary or/and Default number files.

88. The system as claimed in claim 87, wherein said means for updating Default Number file comprises means for updating the Default Number files with data taken by said Switch or received by said ISP from network resources' Secondary Number files,
when a call for a particular network resources is received, said Switch server checks said network resource's Primary URL in Default number file and if the latter is not nil, said Switch connects to said network resource, and
if connection fails, said Switch terminates the call and sets Default Number file Primary URL field to nil and its status field to off-line.

89. The method as claimed in claim 87, wherein said ISP comprises means for obtaining on-line status of at least one of said network resources, and said on-line status is retrieved from said ISP to said Switch server for each particular network source.

90. The system as claimed in claim 10, wherein the Switch server pings continuously all subscribed network resources using their Primary URLs and checking “on-line status” of said network resources continuously, and
wherein each time when on-line status check is complete, the Switch updates the status in the Default number file for each of said network resources.

91. The system as claimed in claim 1, further comprising updating Secondary and Default Number files, wherein while entering network each of said network resources connects to a Switch server and synchronizes its Primary Number file with Default Number file metadata.

92. The system as claimed in claim 91, wherein Switch server continuously communicates with each particular network resource and updates the Default Number files with data taken by said Switch pulls or received from said network resource Primary Number files,
when call for particular network resource is received, said Switch server retrieves from Default Number File a Primary URL of said network resource.

93. The system as claimed in claim 92, wherein
if the Primary URL is not nil, a Switch establishes a connection, and
if the Primary URL is nil or said connection fails, the Switch terminates the call, sets to nil Primary URL field in Default Number file of said network resource, and sets its status field to off-line.

94. The system as claimed in claim 78, wherein said plurality of network resources comprises at least one Mover network resource and at least one Target network resource, said system further comprising:
means for making an outgoing IP call from said Mover network resource to said Target network resource; and
means for entering an UTA of said Target into a web enabling interface of said Mover,
wherein said Mover connects and communicates with said Switch server; and
said Mover receives metadata of said Target from said Default Number file.

95. The system as claimed in claim 94, wherein
if a Primary URL of said UTA is not a nil, said Mover attempts to access said UTA of said Target by using said Primary URL of said UTA taken from Default Number File of said target,
if the Primary URL is valid and said Target responds, the Mover and the Target provide their respective Digital Certificates to each other and make network security policy check;
whereby, depending on said policy, said Mover is provided with access to Primary number file of said Target, and said Target is provided with access to Primary number file of said Mover, said Mover and said Target compute security data applying security policy, and said Mover accesses and exchanges data with the Target if privileges allow.

96. The system as claimed in claim 95, wherein IETF Session Initiation Protocol is used for exchange between said Mover and said Target.

97. The system as claimed in claim 94, wherein when the Primary URL of said Target is valid, said Mover is calling to said Target, and said Target does not answer the call, the browser attempts to leave a message in memory; and
when the Primary URL is not valid or nil the browser retrieves Secondary URL and attempts to locate the Secondary Number File and when a responding sequential URL is found the web browser allows composing and leaving said message.

98. The system as claimed in claim 78, further comprising means for answering an incoming IP call from a Mover network resource received by a Target network resource,
said system further comprising means for automatically turning said Target into receive mode which include providing indication of the incoming IP call;
said Target comprising:
means for attempting to retrieve UTA of said Mover and a Digital Certificate from said Mover Primary Number file;
means for checking UTA and Digital Certificate validity and privileges of said Target; and
means for deciding to allow or to deny connection of said Mover in accordance with security/calling policy, privileges and preferences of both said Target and said Mover provided in metadata of said Number File and said Digital Certificates.

99. The system as claimed in claim 98, wherein if said IP call is a secure call then both said Mover and said Target encrypt the exchange using SSL and PKI, their respective Private and Public keys.

100. The system as claimed in claim 99, wherein said secure call facilitates purchase, payment and other secure transaction services.

101. The system as claimed in claim 99, further comprising, when check, verification, or authentication is complete, means for conducting exchange between said Mover and said Target IETF using Session Initiation Protocol.

102. The system as claimed in claim 78, wherein said plurality of network resources comprises at least one Target and at least one Mover network resource, the system further comprising:
means for establishing communication between said Mover and Target network resources;
means for providing for each particular Target a list of IDs of other networking Targets and Movers related to the particular Target; and
means for dividing said list into parts comprising: first IDs of Targets which are not allowed to see on-line status of the particular Target, second IDs of Targets, which are allowed to see the particular Target's on-line status, third IDs of Movers which are not allowed to call to the particular Target, and fourth IDs of Movers which are allowed to call to the particular Target,
whereby each of said Movers can check and receive on-line status for only said Targets who allow the Mover to check on-line status thereof.

103. The system as claimed in claim 102, wherein a Mover having one of said fourth IDs comprises:
means for checking whether said particular Target is on-line before calling to said particular Target; and
means for stopping attempting to establish communication with said particular Target if said particular Target is currently off-line.

104. The system as claimed in claim 102, wherein said list of IDs comprises telephone numbers of said other Targets.

105. The system as claimed in claim 78, wherein said plurality of network resources comprises at least one Target and at least one Mover network resource, the system further comprising:
means for establishing communication between said Mover and Target network resources,
an UTA Subscription Authority which creates and registers an UTA associated with a particular Target and creates a Primary Number File for the particular Target, and
a Certification Authority (CA) which creates a Digital Certificate (DC),
wherein
said particular Target is SSL enabled,
said particular Target provides required fields of Primary Number File and generates Certificate Signature Request (CSR) file, Public key and Private key files, said Private Key being securely stored in a memory of said particular target;
said particular Target provides its CSR and Public key to the UTA CA for signature, said Public key file and said UTA Primary Number File being encrypted by CA with CA Private Key, and the encrypted message represents a UTA Digital Certificate;
said CA encryptes said CSR and returns said CSR to said particular Target as a Digital Certificate (DC) of said particular Target; and
said particular Target stores said DC in the Primary Number file of said particular Target and makes said DC available for SSL procedure.

106. The system as claimed in claim 105 wherein said required fields are PNF fields with permanent values.

107. The system as claimed in claim 105 wherein said CA is a switch server.

108. The system as claimed in claim 105 wherein said DC includes UTA, and the digital certificate is digitally signed by the CA.

109. The system as claimed in claim 78, wherein said plurality of network resources comprises at least one Target and at least one Mover network resource, the system further comprising:
means for establishing communication between Mover and Target network resources and performing authentication in non-secure mode,
wherein said switch server is a Certification Authority (CA),
said system further comprising:
at least one of the digital Certification Authority, Switch server and a Target network resource taking UTA from Primary Number File of a Mover; retrieving Default, Primary and Secondary Number Files for UTA of said Mover; verifying said UTA of said Mover by comparing key data from Secondary and Default Number Files with those in Primary Number File; and, if said verification is successful, authorizing said Mover to use requested services and providing said Target with verification from said Switch server.

110. The system as claimed in claim 109, wherein SSL is disabled.

111. The system as claimed in claim 78, wherein
said plurality of network resources comprises at least one Target and at least one Mover network resource;
the system further comprises means for establishing communication between Mover and Target network resources and performes authentication in secure mode;
said switch server is a Certification Authority (CA);
a second target network resource authenticates a first target network resource;
said first target comprising:
means for encrypting a fist dataset using a first Private Key thereby forming first new dataset; and
means for composing a fist check message containing a first Digital Certificate (DC) and said first new dataset; and
means for transmitting said first check message to said second target;
said second target comprising:
means for retrieving said first DC and said first new dataset from said fist check message;
means for decrypting said first DC using a Public Key of said CA; and
means for retrieving said first dataset and said Public Key from the decrypted first DC;
means for decrypting said first new dataset using said first Public Key forming a second dataset;
means for comparing said second dataset with said first dataset; and
means for deciding that said first target possess correct first Private Key and the verified first dataset, if said second dataset is identical to said first Dataset, thereby authenticating said first target.

112. The system as claimed in claim 111, wherein SSL is enabled

113. The system as claimed in claim 111, wherein said first dataset is a part of at least one of said first DC, said first UTA, and other first DC fields, or is a part of some or all said first DC fields, or is a first DC.

114. The system as claimed in claim 78, wherein
said plurality of network resources comprises at least one Target and at least one Mover network resource,
the system further comprises means for establishing communication between Mover and Target network resources,
said Target performs verification authentication and authorization of said mover,
said switch server is a Certification Authority (CA), and
said Target further comprises:
means for retrieving Digital Certificate (DC) from a Primary Number File of said Mover via SSL;
means for decrypting the DC with a public key of said CA;
means for checking validity of the DC;
means for authenticating said Mover;
means for allowing said Mover to connect to said Target based on privileges of said Mover if the check is successful; and
means for denying said connection if the check fails.

115. The system as claimed in claim 78, wherein
said plurality of network resources comprises at least one Target and at least one Mover network resource,
the system further comprises means for establishing communication between Mover and Target network resources,
said Mover performs verification authentication and authorization of said Target,
said switch server is a Certification Authority (CA), and
said Mover further comprises:
means for retrieving Digital Certificate (DC) of said Target from PFN of said Target when connecting to said Target;
means for decrypting said DC by using Public Key of said CA; and
means for verifying UTA of said Target and checking privileges of said Target.

116. The system as claimed in claim 78, wherein
said switch server is a Certification Authority (CA), and
said system further comprises means for providing secure transaction services between Buying Target network resources and Selling Target network resources.

117. The system as claimed in claim 116, wherein said means for providing secure transaction services provide said secure transaction services using Secure Socket Layer (SSL), PKI and UTA CA services.

118. The system as claimed in claim 116, wherein said means for providing secure transaction services comprise:
means for processing payment between a Buying target and a Selling target, said Buying Target composing a purchase message, said purchase message comprising:
a DC of said Selling Target; and
Purchase data.

119. The system as claimed in claim 118, wherein said purchase data includes at least one of currency and money values, time of purchase, and purchase/transaction number.

120. The system as claimed in claim 118, wherein said purchase message further comprises a Primary URL of said Selling target.

121. The system as claimed in claim 118, wherein said purchase message is an agreement to buy, digitally encrypted using a Private Key of said Buying target.

122. The system as claimed in claim 118, wherein said Selling Target comprises means for composing a charge message, said charge message comprising:
a DC of said Buying Target;
said Purchase message signed using a Private Key of said Buying target; and
said Purchase data.

123. The system as claimed in claim 122, wherein said charge message further comprises a Primary URL of said Buying target.

124. The system as claimed in claim 122, wherein said charge message is an agreement to sell, digitally encrypted using a Private Key of said Selling Target.

125. The system as claim in claim 122, said system further comprising an Authorization Center for composing an authorization message, said authorization message comprising:
a DC of said Buying Target;
said Purchase message signed using a Private Key of said Buying target; and
said Purchase data.

126. The system as claimed in claim 125, wherein said authorization message further comprises a Primary URL of said Buying target.

127. The system as claimed in claim 125, wherein said authorization message is an authorization, digitally encrypted using a Private Key of said Authorization Center.

128. The system as claimed in claim 125, further comprising:
means for establishing wired or wireless connection between said Buying target and said Selling target;
means for displaying or otherwise indicating purchase/transaction data to said Buying and Selling target, said purchase transaction data comprising a purchase description and a value of said purchase;
means for receiving an authorization of said Buying target for said purchase,
wherein, if said authorization is granted:
executing Buyer/Seller cross-authentication;
if said Selling Target and said Buying target are authentic, then
said Buying target composes said purchase message;
said Buying target connects to the Authorization Center using Primary URL of the Authorization Center;
said Buying target executes cross-authentication with the Authorization Center; said Buying target transmits said purchase message to the Authorization Center; and
either:
said Authorization Center decrypts said purchase message using said Public Key of said Buying target taken from DC of said Buying target during authentication;
said Authorization Center composing said authorization message;
said Authorization Center transmitting said Authorization message to said Buying target;
said Buying target transmits said Authorization message to said Selling target;
the Selling target decrypts said Authorization message using a Public key of said Authorization Center;
or:
said Authorization Center resolves via said Switch server Primary URL of said Selling target using UTA of said Seller taken from DC of said Selling target, or takes Primary URL of said Selling Target from said Purchase message;
said Authorization Center connects to said Selling target using said Primary URL of said Selling target;
said Authorization Center authenticates the Selling target and if Selling target is authentic:
said Authorization Center verifies said Selling Target and said Buying target, and said purchase data;
said Authorization Center composes said Authorization message;
said Authorization Center transmits said Authorization message to said Selling target; and
said Selling target decrypts said Authorization message using said Public key of said Authorization Center.

129. The system as claimed in claim 128, wherein the Seller allows the purchase if the payment is authorized.

130. The system as claimed in claim 128, wherein said Buyer/Seller cross-authentication is a Strong Buyer/Seller cross-authentication in secure mode.

131. The system as claimed in claim 125, further comprising:
means for establishing wired or wireless connection between said Buying target and said Selling target;
means for displaying or otherwise indicating purchase/transaction data to said Buying and Selling target, said purchase transaction data comprising a purchase description and a value of said purchase; and
means for receiving an authorization of said Buying target for said purchase, wherein, if said authorization is granted:
executing Buyer/Seller cross-authentication;
if said Selling Target and said Buying target are authentic, then
said Buying target composes said purchase message;
said Buying target transmits said purchase message to said Selling target;
said Selling target decrypts said purchase message using a Public Key of said Buying target taken from DC of said Buying target, verifies the purchase data, and if applicable to policy and if purchase data is correct then
said Selling Target composes said Charge message;
said Selling Target connects to said Authorization Center using Primary URL of said Authorization Center;
said Selling Target executes cross-authentication with the Authorization Center, and if cross-authentication succeeds:
said Selling target transmits said Charge message to said Authorization Center;
said Authorization Center decrypts said Charge message using a Public Key of said Selling target and retrieves and decrypts said Purchase message using said Public Key of said Buying target taken from said DC of said Buying target;
said Authorization Center verifies the purchase data, and Selling and Buying targets;
said Authorization Center composes said Authorization message;
said Authorization Center transmits said Authorization message to said Selling target; and
said Selling target decrypts said Authorization message using Public key of said Authorization Center.

132. The system as claimed in claim 131, wherein said Selling target allows the purchase if the payment is authorized.

133. The system as claimed in claim 131, wherein said Selling target executes Strong cross-authentication with the Authorization Center in secure mode.

134. The system as claimed in claim 78, wherein said internet service provider is said switch server and said second number file is said default number file.

135. A system for wireless or wired network communication comprising:
means for issuing a temporary Digital Certificates containing UTA for use in at least one Temporary Target (TT), said TT serving as a temporary Target or Mover in the network; and
a CA Switch;
wherein said CA Switch issues UTA and UTA DC, transfers the UTA and DC directly to a Temporary Target Number File or to a reseller, and the reseller assigns the UTA/DC to a particular temporary Target Primary Number File.

136. The system as claimed in claim 135, wherein said TT is a disposable handset which uses at least one of Transaction, Text, Voice and Video over an IP exchange only and with or without assignment of a permanent network UTA.

137. The system as claimed in claim 135, wherein when a TT is turned on, said TT prompts a user to manually enter a UTA, or to use a particular preset UTA.

138. The system as claimed in claim 135, wherein, when a TT is turned on, said TT is set to automatically choose a dynamic UTA provided by a network.

139. The system as claimed in claim 137, wherein
the user chooses to use a particular UTA, the TT request the user to enter a password for the temporary UTA, to verify the user's rights to use the UTA; when the password is stored, handset connects to UTA issuing authority server via SSL and verifies the password for the temporary UTA, or verifies the password with an encrypted password record contained in a secured memory area of the TT; if the check is successful, the user is granted access to network resources using chosen UTA and is treated as an original UTA user; if the check fails the handset can be denied, blocked or reported stolen based on security policy; or
a particular UTA with DC is assigned and remains valid through a predetermined period of time or a number of connections/transactions for the handset/software, and, if assigned, the particular UTA is subject to confirmation for use by the user;

140. The system as claimed in claim 139, wherein the password is similar to a Personal Identification Number for a GSM SIM card.

141. The system as claimed in claim 139, wherein the UTA issuing authority is one of a CA, Switch, ISP and reseller.

142. The system as claimed in claim 138, wherein, when the TT is turned on for the first time,
the TT connects via Internet to a Switch server;
the Switch server registers the TT in the network and assigns dynamic UTA and temporary Default Number File for the TT;
wherein the Default Number File is a copy of Primary Number File; the dynamic UTA is used only for duration of each particular call unless the user requires to hold the UTA for a standard period of time or based on other standard terms of use.

143. The system as claimed in claim 142, wherein Dynamic UTA is being revoked after the call is disconnected or assigned and held for the TT for a standard period of time if required by the user.

144. The system as claimed in claim 142, wherein, to retrieve the UTA, TT is enabled to update its Primary Number File with a particular UTA and the CA issues a DC containing the UTA and assigns the DC the handset.

145. The system as claimed in claim 78, wherein the PNF is used as a Digital Identity Dataset comprising all identifying information required for particular verification, authentication, and authorization and transaction purposes.

146. A system for session encryption comprising a plurality of targets in a network or on an Internet, wherein Targets use shorter key pairs in order to accelerate encryption of on-line audio and video streams, each said Targets comprising:
means for issuing new pair of shorter public and private keys;
means for storing the private key in an internal memory of said Target, said private key being used only for one session;
means for encrypting a new shorter public key with a sending target original private key, or with a receiving target original public key; and
means for transmitting the encrypted message to the receiving target,
wherein a receiving target decrypts the received message containing the new shorter Public Key of the sending target and uses the received sending target public key to encrypt/decrypt the session exchange with sending target.

147. The system as claimed in claim 146, wherein the target encrypts a message using the receiving target public key and the receiving target decrypts the message using the receiving target's private key.

148. The system as claimed in claim 146, wherein the target encrypts a message using the sending target's private key and the receiving target decrypts the message using the sending target's public key.

149. The system as claimed in claim 100, wherein at least one of said purchase, payment and other secure transaction services uses a credit card, said credit card having a credit card record (CCR).

150. The system as claimed in claim 149, wherein said CCR is recorded on the credit card magnet stripe or in the smart card internal memory.

151. The system as claimed in claim 149, further comprising means for performing credit card authorization wherein the CCR is retrieved from the credit card and saved in the Target's secure area metadata.

152. The system as claimed in claim 151, wherein if it is required to change CCR when authorizing a particular transaction, the changed CCR is changed by a Credit Card system issuing the card and returned to the Target encrypted using the Target Public Key, then the received CCR is decrypted by the Target using the Private Key of the target and stored in the Target's secure area metadata.

153. The system as claimed in claim 100, wherein at least one of said purchase, payment and other secure transaction services uses a bank charge account.

154. The system as claimed in claim 153, wherein said bank charge account is one of a checking account and a savings account.

155. The method as claimed in claim 1 further comprising selling said UTA, which is valid on at least one of a period of time, or number of uses thereof, and a fixed money value of services provided.

156. The method as claimed in claim 2 further comprising selling said digital certificate, wherein UTA is a main verifiable part of said digital certificate and privileges contain terms of use of said digital certificate based on at least one of a period of time, or number of uses thereof, and a fixed money value of services provided.

157. The method as claimed in claim 1, wherein said network comprised permanent and temporary targets, said method further comprising selling said PNF with a permanent UTA for permanent Targets or without said permanent UTA for Temporary Targets.

158. The method as claimed in claim 1, further comprising:
recording at least one of said PFN on a recordable medium; and
selling said recordable medium having said at least one of said PNF recorded thereon.

159. The method as claimed in claim 158, wherein said recordable medium is a portable recordable medium.

160. The method as claimed in claim 159, wherein said portable medium is one of a SIM card for GSM and/or 3G standards, a CD and a DVD.

161. The method as claimed in claim 185, wherein said recordable medium is a recordable memory chip or processor.

162. The method as claimed in claim 1, further comprising selling said PNF as a Digital Identity Dataset.

163. The method as claimed in claim 1, further comprising selling said UTA and/or said PNF on per resolution charge basis.

164. The method as claimed in claim 1, further comprising selling said UTA and/or PNF to a third party on per provision charge basis.

165. The method as claimed in claim 1, further comprising selling said UTA and/or PNF authentication services on per authentication charge basis.

166. The method as claimed in claim 1, further comprising selling said UTA and/or PNF charge authorization services on per authorization charge basis.

167. The method as claimed in claim 1, further comprising:
storing, on a recordable medium, an instruction set comprising instructions for executing steps of:
said forming said PNF;
said forming said secondary and said default number files; and
said storing of said secondary and default number files.

168. The method as claimed in claim 167, further comprising selling said recordable medium.

169. A computer-readable medium carrying out one or more sequences of instructions for performing wireless or wired network communication between network resources each having a unique telephone number associated therewith, wherein execution of the one or more sequences of instructions by one or more processors causes the one or more processors to perform the steps of:
forming a primary number file (PNF) comprising a uniform telephone address (UTA) which has a telephone number associated with a network resource;
forming a secondary number file and a default number file, said secondary and default number files being mirror images of said primary number file;
storing said default number file at a switch server which provides connectivity services for said network resources and is itself a network resource; and
storing said secondary number file at an internet service provider.

170. A computer-readable medium carrying out one or more sequences of instructions for performing wireless or wired network communication between network resources each having a unique telephone number associated therewith, wherein execution of the one or more sequences of instructions by one or more processors causes the one or more processors to perform the steps of:
issuing a temporary Digital Certificates containing UTA for use in at least one Temporary Target (TT), said TT serving as a temporary Target or Mover in the network,
wherein a CA Switch issues UTA and UTA DC; transfers the UTA and DC directly to Temporary Target Number File or to a reseller; and the reseller assigns the UTA/DC to a particular temporary Target Primary Number File.

171. A computer-readable medium carrying out one or more sequences of instructions for performing session encryption, wherein Targets use shorter key pairs in order to accelerate encryption of on-line audio and video streams, wherein execution of the one or more sequences of instructions by one or more processors causes the one or more processors to perform the steps of:
each Target
issuing new pair of shorter public and private keys;
storing the private key in an internal memory of said Target, said private key being used only for one session;
encrypting a new shorter public key with a sending target original private key, or with a receiving target original public key; and
transmitting the encrypted message to the receiving target; and
receiving target decrypting the received message containing the new shorter Public Key of the sending target and uses the received sending target public key to encrypt/decrypt the session exchange with sending target.

172. A computer data signal embodied in a carrier wave, the computer data signal carrying one or more sequences of instructions for performing wireless or wired network communication between network resources each having a unique telephone number associated therewith, wherein execution of the one or more sequences of instructions by one or more processors causes the one or more processors to perform the steps of:
forming a primary number file (PNF) comprising a uniform telephone address (UTA) which has a telephone number associated with a network resource;
forming a secondary number file and a default number file, said secondary and default number files being mirror images of said primary number file;
storing said default number file at a switch server which provides connectivity services for said network resources and is itself a network resource; and
storing said secondary number file at an internet service provider.

173. A computer data signal embodied in a carrier wave, the computer data signal carrying one or more sequences of instructions for performing wireless or wired network communication between network resources each having a unique telephone number associated therewith, wherein execution of the one or more sequences of instructions by one or more processors causes the one or more processors to perform the steps of:
issuing a temporary Digital Certificates containing UTA for use in at least one Temporary Target (TT), said TT serving as a temporary Target or Mover in the network,
wherein a CA Switch issues UTA and UTA DC; transfers the UTA and DC directly to Temporary Target Number File or to a reseller; and the reseller assigns the UTA/DC to a particular temporary Target Primary Number File.

174. A computer data signal embodied in a carrier wave, the computer data signal carrying one or more sequences of instructions for performing session encryption, wherein Targets use shorter key pairs in order to accelerate encryption of on-line audio and video streams, wherein execution of the one or more sequences of instructions by one or more processors causes the one or more processors to perform the steps of:
each Target
issuing new pair of shorter public and private keys;
storing the private key in an internal memory of said Target, said private key being used only for one session;
encrypting a new shorter public key with a sending target original private key, or with a receiving target original public key; and
transmitting the encrypted message to the receiving target; and
receiving target decrypting the received message containing the new shorter Public Key of the sending target and uses the received sending target public key to encrypt/decrypt the session exchange with sending target.
